(19) United States
(12) Patent Application Publication
(10) Pub. No.: US 2016/0036664 A1
(43) Pub. Date: Feb. 4, 2016

(54) CONTINUED DEEP PACKET INSPECTION CLASSIFICATION AFTER ROAMING

(71) Applicant: Aruba Networks Inc., Sunnyvale, CA (US)

(72) Inventors: Amit Madan, Bangalore (IN); Sandeep Unnimadhavan, Bangalore (IN); Jagachittes Vadivelu, Bangalore (IN)

(21) Appl. No.: 14/446,819

(22) Filed: Jul. 30, 2014

(51) Int. Cl. H04L 12/26

(52) U.S. Cl. CPC H04L 43/065; H04L 43/12

(57) ABSTRACT

A non-transitory computer readable medium when executed by one or more devices, causes performance of operations including forwarding, by a network device, a set of messages corresponding to a particular connection to a server, the set of messages being forwarded between a client device and a server via the network device, receiving, by the network device, a copy of a second set of messages corresponding to the particular connection that are transmitted between the client device and the server via without being transmitted through the network device, and analyzing, by the network device, both sets of messages to obtain a classification associated with the particular connection to the server.

### BACKGROUND

WiFi® is becoming more and more prevalent as time passes. Many people are now constantly connected to the Internet via WiFi®, and WiFi® usage is expected to continue to increase. To ensure a strong WiFi® connection, more than one network device is needed to supply the wireless signal. As users move around, or roam, they may need to switch to a different network device. Depending on when the roam occurs, there may be unintended consequences.

### OVERVIEW

In general, in one aspect, the invention relates to a non-transitory computer readable medium comprising instructions. The instructions, when executed by one or more devices, cause performance of operations comprising: forwarding, by a first network device, a first set of messages corresponding to a particular connection to a server, the first set of messages being forwarded between a client device and a server via the first network device; receiving, by the first network device, a copy of a second set of messages corresponding to the particular connection that are transmitted between the client device and the server via without being transmitted through the first network device; and analyzing, by the first network device, both the first set of messages and the second set of messages to obtain a classification associated with the particular connection to the server.

In general, in one aspect, the invention relates to a non-transitory computer readable medium comprising instructions. The instructions, when executed by one or more devices, cause performance of operations comprising: forwarding, by a first network device, a first set of messages corresponding to a particular connection to a server, the first set of messages being forwarded between a client device and a server via the first network device; analyzing, by the first network device, the first set of messages to obtain a first classification information; receiving, by the first network device, a second classification information for a second set of messages corresponding to the particular connection that are transmitted between the client device and the server via without being transmitted through the first network device; and determining a classification for the particular connection to the server based on both the first classification information and the second classification information.

In general, in one aspect, the invention relates to a non-transitory computer readable medium comprising instructions. The instructions, when executed by one or more devices, cause performance of operations comprising: forwarding, by a first network device, a first set of messages corresponding to a particular connection to a server, the first set of messages being forwarded between a client device and a server via the first network device without being transmitted through a second network device or a third network device; forwarding, by a second network device, a second set of messages corresponding to the particular connection to the server, the second set of messages being forwarded between the client device and the server without being transmitted through the first network device or the third network device; receiving, by the third network device, a copy of the first set of messages from the first network device and a copy of the second set of messages from the second network device; and analyzing, by the third network device, both the first set of messages and the second set of messages to obtain a classification associated with the particular connection to the server.

Other aspects and advantages of the invention will be apparent from the following description and the appended claims.

### BRIEF DESCRIPTION OF DRAWINGS

FIG. 1 shows a schematic diagram in accordance with one or more embodiments of the invention.

FIG. 2 shows a flowchart of a method in accordance with one or more embodiments of the invention.

FIGS. 3A-3D show an example in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a computer readable medium for continued deep packet inspection (DPI) after roaming. A network device forwards messages corresponding to a particular connection to a server from a client device to the server. The network device may receive a copy of a second set of messages corresponding to the same connection to the server that were transmitted between the client device and a server from a second network device. The network device is then able to analyze the messages to obtain a classification.

Deep packet inspection (DPI) is a form of network packet filtering, and may be used for many different purposes. A message sent from one computing device to another takes the form of one or more packets. These packets may be forwarded amongst and/or between any number of intermediate devices before they reach their destination(s). DPI involves inspecting the contents of these packets at an inspection point. An inspection point may be any device in the path from the sending device/starting point to the receiving device/end point. In some instances, the inspection point may be a device that is not a direct part of the path the messages travels. For example, if a messages travels from device A to device B to device C, device B may send the message to device Z for DPI.

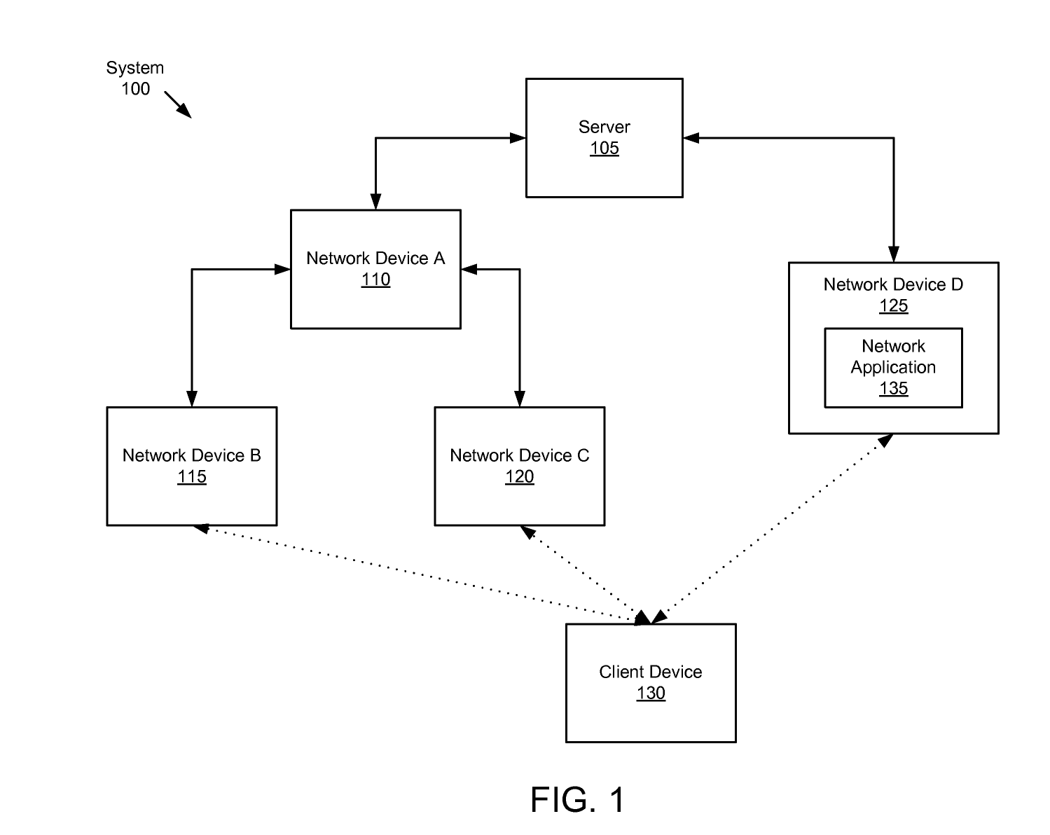

FIG. 1 shows a system (100) in accordance with one or more embodiments. As shown in FIG. 1, the system (100) has multiple components, including a server (105), one or more network devices (e.g., network device A (110), network device B (115), network device C (120), and network device D (125)), a client device (130), and one or more network application (135). In one or more embodiments, the server (105) and the network devices (110, 115, 120, and 125) are connected via a network. The network may be a network of any size including the Internet, and may contain any number of wired and/or wireless connections. In one or more embodiments, the network devices (110, 115, 120, and 125) are located within the same secondary network (e.g., an IP subnet), and/or are in the same level (e.g., Level 2) in the Open Systems Interconnection Model (OSI). Alternatively, some network devices may be located in different secondary networks and/or on different levels from other network devices. In one or more embodiments, the server (105) is in a different secondary network (e.g., different IP subnet) and/or level than the network devices (110, 115, 120, and 125).

In one or more embodiments, server (105) is a server, rack, computer, laptop, smart phone, tablet computer, or other suitable device that sends and/or receives data to/from client device (130) via an intermediate device(s), such as one or more network devices (110, 115, 120, and 125). For example, server (105) may be a web server hosting a video that client device (130) is streaming. In one or more embodiments, server (105) is owned, controlled, or operated, by a party different than the party that owns, controls, or operates one or more network device (110, 115, 120, and 125). Alternatively, server (105) may be owned, controlled, or operated by the same party as one or more network devices (110, 115, 120, and 125). In one or more embodiments, server (105) may be a network device, as described below.

In one or more embodiments, the client device (130) may be a computing system capable of wirelessly sending and/or receiving information. For example, the client device (130) may be a laptop computer, smart phone, personal digital assistant, tablet computer, or other mobile device. In one or more embodiments of the invention, there may be any number of applications (not shown) executing on client device (130) for many different purposes. These applications may send packets to other devices, such as server (105), and these packets may cause many different actions to be performed. These applications and/or actions may be classified using DPI. In one or more embodiments of the invention, the particular connection between client device (130) and server (105) may be identified by at least one Open Systems Interconnection (OSI) layer 4 parameter, at least one Internet Protocol (IP) address for the client device (130), and at least one IP address for server (105).

In one or more embodiments, each network device (110, 115, 120, and 125) is a hardware device that is configured to receive packets (e.g., unicast packets, multicast packets) and transmit the packets to other devices connected to the network device, such as client device (130), server (105), or other network devices (110, 115, 120, and 125). The network device may include one or more hardware processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The hardware processor(s) may be an integrated circuit for processing instructions. For example, the hardware processor(s) may be one or more cores, or micro-cores of a processor.

By way of an example, a client device may be directly wired or wirelessly communicatively connected to a single access point, which is directly communicatively connected to a single controller, which is connected to a network (not shown). In the example, the network device may be the access point, the controller, an access point that includes the functionality of a controller, a switch (e.g., mobility access switch), or other such device. Additionally, by way of an example, one network device may be a controller while another network device may be an access point. The network device that is the access point in the example may or may not be connected to the network via the network device that is a controller.

Access points are digital devices that may be communicatively coupled to one or more networks (e.g., Internet, an intranet, etc.). Access points may be directly connected to the one or more networks or connected via a controller. In other words, an access point may be directly connected to a particular controller. An access point may include a wireless access point (WAP) that communicates wirelessly with devices using WiFi®, Bluetooth®, or related standards and that communicates with a wired network.

In one or more embodiments of the invention, although network application (135) is shown on only network device D (125), network application (135) may be installed on any, or all, of the network devices (110, 115, 120, and 125). Network application (135) may be installed by the manufacturer of the network device, or may be installed by the user, administrator, or other suitable entity. Network application (135) includes functionality for DPI, communicating with other network devices, and identifying partially classified connections, among other functionalities.

In one or more embodiments, each network application (135) includes functionality for performing DPI. The DPI may be performed in any manner now known or later developed. In one or more embodiments of the invention, the DPI may be used to classify a particular connection to a server. Specifically, the classification may identify the type of activity or application that is being performed and/or using the messages which are being inspected. In one or more embodiments of the invention, more than one packet may be required to properly classify a particular connection to a server. For example, it may take 2 packets to identify that a particular connection to a server is a social network chat function instead of merely viewing the social network. It will be apparent to one of ordinary skill in the art that any number of packets may be required to properly classify a particular connection to a server and, as such, the invention should not be limited to the above example.

In one or more embodiments of the invention, network application (135) includes functionality for identifying which connections to a server are partially classified. A partially classified connection is one for which DPI has not yet been completed, and therefore the connection has not been classified. For example, if a connection involves a chat application on a social network, and only 1 packet was received by a given network device before a roam occurred, then performing DPI on the 1 packet will not enable the connection to be classified, as 2 or more packets are needed to properly determine that the packets relate to a chat application on a social network. Thus, in this example, the connection may be identified as partially classified. Further, partially classified connections may be stored in any suitable manner on the network device associated with network application (135).

In one or more embodiments of the invention, network application (135) includes functionality for determining when a client roams from one network device to another. Further, network application (135) includes functionality for identifying the prior network device when a client device roams, and includes functionality for querying the prior network device to request a list of partially classified connections from the prior network device. The prior network device may be identified in any suitable manner, such as using data contained within the packets, or firewall information. The network devices (110, 115, 120, and 125) may communicate using any method or manner now known or later developed including, but not limited to: tunneling protocols such as Generic Routing Encapsulation (GRE), network sockets such as Transmission Control Protocol (TCP), User Datagram Protocol (UDP), raw sockets, and/or any other method.

In one or more embodiments of the invention, network application (135) includes functionality for copying packets to a prior network device when the packets relate to a connection that was partially classified by the prior network device. Thus, the prior network device uses the copied packets, in addition to the packet(s) used to partially classify the connection, to complete classification of the particular connection. The prior network device may subsequently inform the new network device of the classification. Alternatively, the prior network device may copy the packets used to generate a partial classification to the new network device, thereby allowing the new network device to perform DPI on the packets from both network devices and classify the connection. Alternatively, in one embodiment, rather than copying the packets to the old or new network device, classification information may be copied. In other words, the information generated by performing DPI on a packet(s) may be copied to another network device, whether new or old. The packets may be copied using any method or manner now known or later developed including, but not limited to: GRE, TCP, UDP, raw sockets, and/or any other method. It will be apparent to one of ordinary skill in the art that any number of packets may be copied from one network device to another, and/or any type or amount of classification information may be copied from one network device to another and, as such, the invention should not be limited to the above examples.

In one or more embodiments of the invention, network application (135) includes functionality for handling multiple roams during a classification. Multiple roams may be handled by copying and/or sending all packets or classification information to the original (i.e., first) network device associated with the particular connection. The DPI may then be performed at the original network device and, once a classification is determined, the current network device will be notified of the classification. Alternatively, network application (135) may designate a separate network device that is not used in forwarding messages between the client and the server as the location for DPI to be performed, for either single or multiple roams. In this embodiment, packets or partial classification information may be sent from two or more network devices to the separate network device, where classification will be performed, and, once classification is complete, the separate network device will send the classification to at least the network device that the client device is currently in communication with.

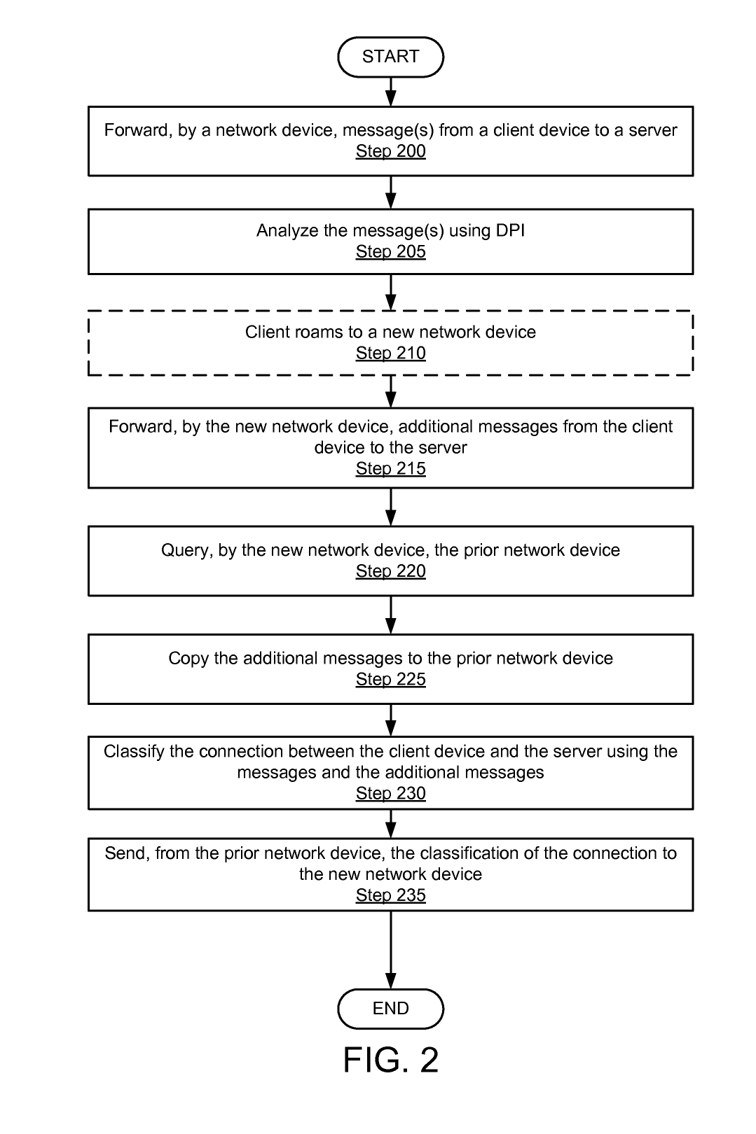

FIG. 2 shows a flowchart of a method for continued DPI classification after roaming. While the various steps in this flowchart are presented and described sequentially, one of ordinary skill in the art will appreciate that some or all of the steps may be executed in different orders and some or all of the steps may be executed in parallel. Further, in one or more embodiments of the invention, one or more of the steps described below may be omitted, repeated, and/or performed in a different order. Accordingly, the specific arrangement of steps shown in FIG. 2 should not be construed as limiting the scope of the invention.

In Step 200 message(s) are forwarded, from a client device to a server, by a network device, in accordance with one or more embodiments. The message(s) may comprise any number of individual packets, and may be formatted in any manner now known or later developed. The message(s) may be forwarded amongst any number of network devices before reaching the server. The messages may represent a particular connection to a server by the client device.

In Step 205, the message(s) are analyzed using DPI, in accordance with one or more embodiments. The message(s) may be analyzed by the network device which forwarded the message(s) in Step 200. The DPI may be performed in any manner now known or later developed. Sometimes, in one or more embodiments of the invention, the DPI may result in a partial classification of the connection. This partial classification may be flagged, or otherwise noted, by the network device.

In Step 210, the client roams to a new network device, in accordance with one or more embodiments. Step 210 may occur at any time in the method, and need not occur directly after Step 205, or any other step. For example, the roam may occur simultaneously with Step 205 or before Step 205. Further, as indicated by the dotted lines, Step 210 occurs based on the client device moving out of range of the network device, or another network device having a stronger signal, or any other suitable reason for a roam.

In Step 215, additional messages are forwarded, from the client device to the server, by a new network device, in accordance with one or more embodiments. The new network device may be any type of network device, and is specifically the network device to which the client device roamed. The additional messages correspond to the same connection to the server as those forwarded by the network device in Step 200.

In Step 220, the prior network device is queried by the new network device, in accordance with one or more embodiments. The prior network device may be queried in any manner now known or later developed. In one or more embodiments of the invention, the prior network device may identify some, or all, of the classified connections which the prior network device deems to be partially classified, and provide this listing to the new network device.

In Step 225, the additional messages are copied to the prior network device, in accordance with one or more embodiments. The additional messages may be sent to the prior network device in any manner or format now known or later developed. Any number of packets from the message(s) may be sent to the prior network device. Alternatively, in one or more embodiments, rather than copying the additional messages, classification information may be exchanged between the prior network device and the new network device. For example, the prior network device may send the classification information obtained from performing DPI on the messages forwarded by the prior network device. Alternatively, the new network device may send the classification information obtained from performing DPI on the additional messages to the prior network device.

In Step 230, the connection to between the client device and the server is classified using the message(s) and the additional message(s), in accordance with one or more embodiments. The classification is determined using DPI in any manner now known or later developed. In one or more embodiments, the classification is not possible without both the message(s) and the additional message(s). In other words, with only the message(s) or only the additional messages, classification will be partial and or incomplete. The classification may identify and/or be based on any suitable aspect of the message(s)/additional message(s). For example, the classification may identify the application that is sending the message(s), the specific action being taken (e.g., attaching a file to an e-mail, sending a chat message, etc.), or any other suitable aspect.

In Step 235, the classification of the connection is sent from the prior network device to the new network device, in accordance with one or more embodiments. The classification may be sent in any manner now known or later developed. Once received, the classification may be used by the new network device to monitor, regulate, or perform other actions in relation to the connection between the client device and the server. For example, the classification may indicate that the network device should prevent the client device from sending attachments in a non-approved e-mail client, although e-mails without attachments are allowed. Similarly, if a classification indicates that the messages are for a social network chat application, the packets relating to chatting my be rejected, thereby preventing the client device from using the chat application, even though the client device may still be allowed to visit/use other aspects of the social network.

The following section describes various examples of the invention. The examples are included to aid in the understanding of the invention and are not intended to limit the scope of the invention.

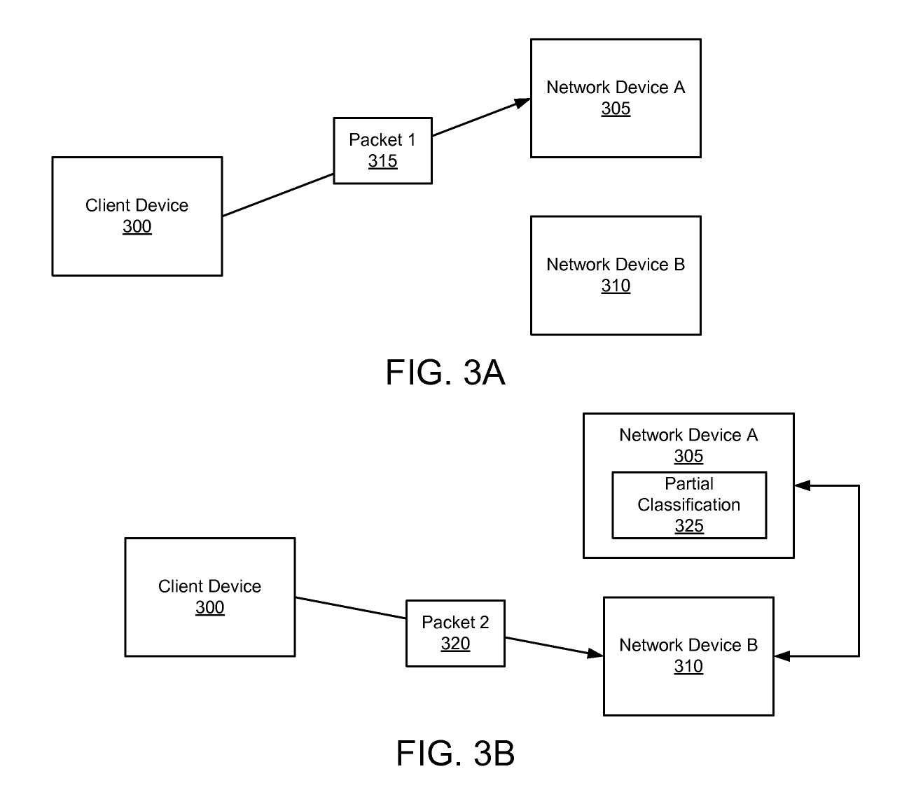

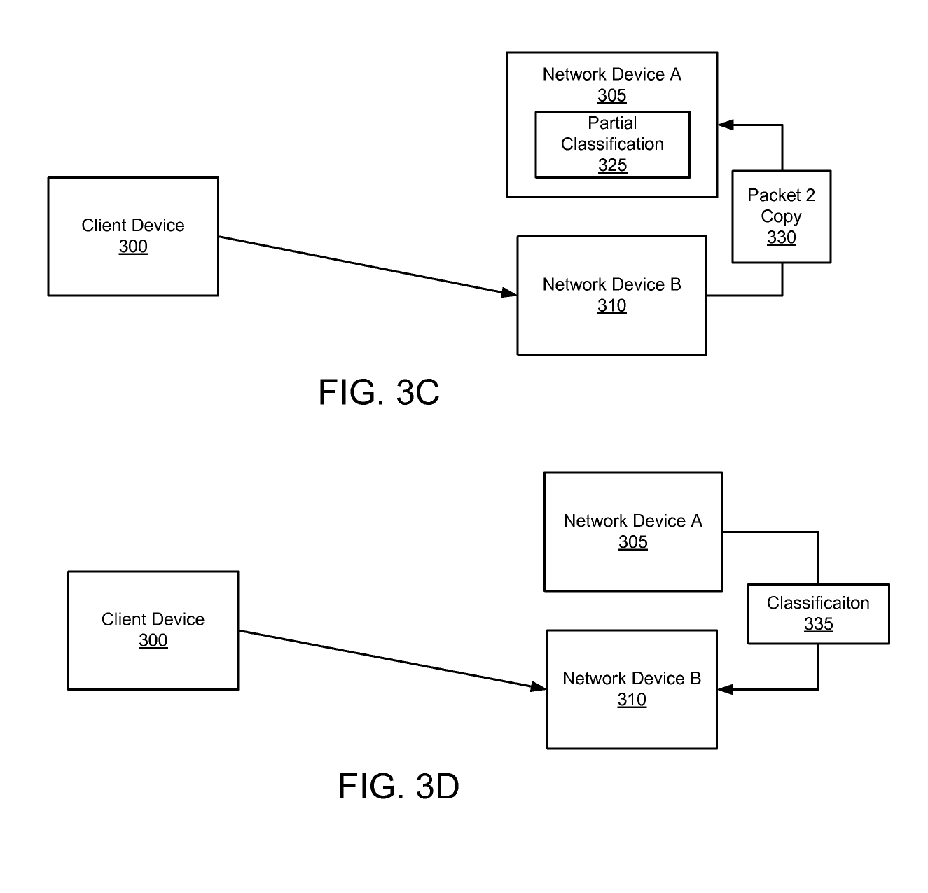

FIGS. 3A-3D show an example in accordance with one or more embodiments. In FIG. 3A, client device (300) is sending packet 1 (315) to a server (not shown) via network device A (305). Network device B (310) is also present, but the client device is not connected to network device B (310). Upon receipt of packet 1 (315), network device A (305) will forward the packet to the server, and begin to perform DPI on packet 1 (315). The results of which are shown in FIG. 3B.

In FIG. 3B, the client device (300) has roamed to network device B (310), and is therefore sending packet 2 (320) to the server (not shown) via network device B (310). Network device A (305), in the meantime, has completed DPI of packet 1 (315) of FIG. 3A, which has resulted in partial classification (325). Partial classification (325) is an incomplete classification and, in order to complete the classification, packet 2 (320) is needed. Thus, network device B (310) contacts network device A (305) and receives partial classification (325). Network device B (310) may then use partial classification to determine that packet 2 (320) is related to partial classification (325) and that a copy of packet 2 (320) should be sent to network device A (305). The example continues in FIG. 3C.

In FIG. 3C, network device B (310) is sending packet 2 copy (330) to network device A (305). Network device A (305) may then use packet 2 copy (330) in conjunction with either a copy of packet 1 (315) of FIG. 3A (not shown), or the partial classification (325), to finish classification of the connection between client device (300) and the server (not shown). Without packet 2 copy (330) network device A (305) is unable to complete classification.

Finally, in FIG. 3D, classification (335) has been generated by network device A (305), and is sent to network device B (310) through which client device (300) is still communicating with the server. Network device B (310) will be able to use classification (335) to block, augment, limit, or otherwise modify the connection and/or allowable actions of client device (300) in the connection with the server.

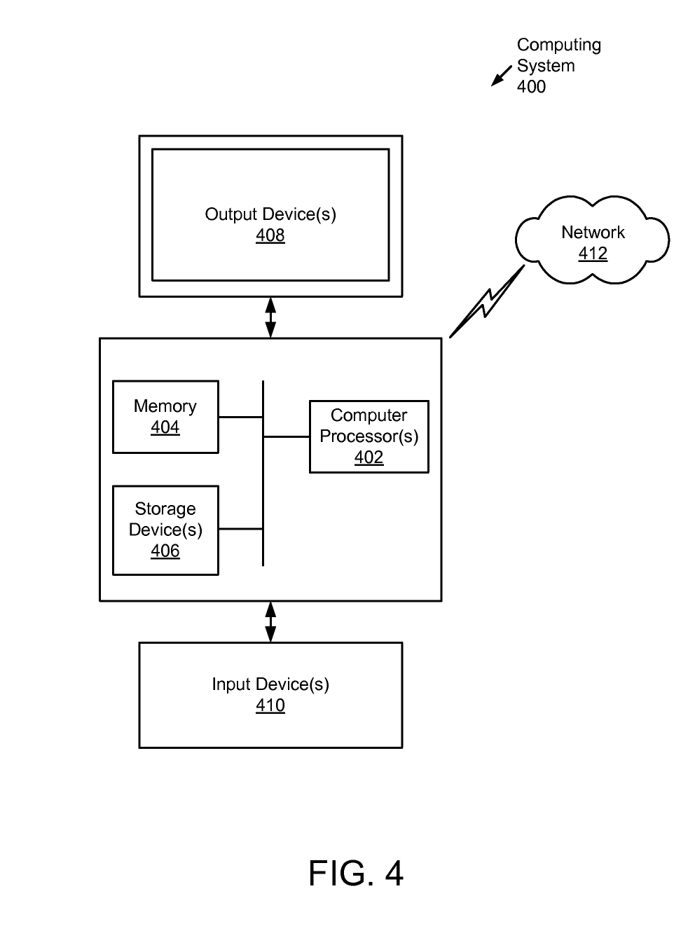

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (412). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A non-transitory computer readable medium comprising instructions which, when executed by one or more devices, causes performance of operations comprising:
forwarding, by a first network device, a first set of messages corresponding to a particular connection to a server, the first set of messages being forwarded between a client device and a server via the first network device;
receiving, by the first network device, a copy of a second set of messages corresponding to the particular connection that are transmitted between the client device and the server via without being transmitted through the first network device; and
analyzing, by the first network device, both the first set of messages and the second set of messages to obtain a classification associated with the particular connection to the server.

2. The non-transitory computer readable medium of claim 1,
wherein the first network device is a first access point,
wherein the client device is associated with the first access point during the transmission of the first set of messages,
wherein the client device is associated with a second access point during the transmission of the second set of messages, and
wherein the copy of the second set of messages is received by the first access point from the second access point.

3. The non-transitory computer readable medium of claim 1,
wherein the first network device is a first controller controlling a first access point,
wherein the client device is associated with the first access point during the transmission of the first set of messages,
wherein the client device is associated with a second access point during the transmission of the second set of messages,
wherein the second access point is controlled by a second controller different than the first controller, and
wherein the copy of the second set of messages is received by the first controller from the second controller.

4. The non-transitory computer readable medium of claim 1,
wherein the first network device is a first switch connecting a first access point to the server,
wherein the client device is associated with the first access point during the transmission of the first set of messages,
wherein the client device is associated with a second access point during the transmission of the second set of messages,
wherein a second switch connects the second access point to the server, and
wherein the copy of the second set of messages is received by the first switch from the second switch.

5. The non-transitory computer readable medium of claim 1, wherein the classification associated with the particular connection indicates an application type associated with the particular connection to the server.

6. The non-transitory computer readable medium of claim 1, wherein at least a portion of the first set of messages and at least a portion of the second set of messages are needed for obtaining the classification for the particular connection.

7. The non-transitory computer readable medium of claim 1, wherein the operations further comprise:
obtaining, by a second network device, information identifying the first network device as a classifying device for classifying the particular connection to the server;
wherein the second set of messages are transmitted to the first network device by the second network device; and
subsequent to the client device switching an association with the second network device to the third network device:
transmitting, by the second network device to the third device, the information identifying the first network device as the classifying device for classifying the particular connection to the network.

8. The non-transitory computer readable medium of claim 1, wherein the particular connection to the server comprises:
at least one Open Systems Interconnection (OSI) layer 4 parameter;
a first Internet Protocol (IP) address for the client device; and
a second IP address for the server.

9. A non-transitory computer readable medium comprising instructions which, when executed by one or more devices, causes performance of operations comprising:
forwarding, by a first network device, a first set of messages corresponding to a particular connection to a server, the first set of messages being forwarded between a client device and a server via the first network device;
analyzing, by the first network device, the first set of messages to obtain a first classification information;
receiving, by the first network device, a second classification information for a second set of messages corresponding to the particular connection that are transmitted between the client device and the server via without being transmitted through the first network device; and
determining a classification for the particular connection to the server based on both the first classification information and the second classification information.

10. The non-transitory computer readable medium of claim 9, wherein the first set of messages is exchanged between the client device and the server prior to the second set of messages.

11. The non-transitory computer readable medium of claim 9,
wherein the first network device is a first access point,
wherein the client device is associated with the first access point during the transmission of the first set of messages,
wherein the client device is associated with a second access point during the transmission of the second set of messages, and
wherein the second classification information is received by the first access point from the second access point.

12. The non-transitory computer readable medium of claim 9,
wherein the first network device is a first controller controlling a first access point,
wherein the client device is associated with the first access point during the transmission of the first set of messages,
wherein the client device is associated with a second access point during the transmission of the second set of messages,
wherein the second access point is controlled by a second controller different than the first controller, and
wherein the second classification information is received by the first controller from the second controller.

13. The non-transitory computer readable medium of claim 9,
wherein the first network device is a first switch connecting a first access point to the server,
wherein the client device is associated with the first access point during the transmission of the first set of messages,
wherein the client device is associated with a second access point during the transmission of the second set of messages,
wherein a second switch connects the second access point to the server, and
wherein the second classification information is received by the first switch from the second switch.

14. The non-transitory computer readable medium of claim 9, wherein the classification associated with the particular connection indicates an application type associated with the particular connection to the server.

15. The non-transitory computer readable medium of claim 9, wherein at least a portion of the first set of messages and at least a portion of the second set of messages are needed for obtaining the classification for the particular connection.

16. The non-transitory computer readable medium of claim 9, wherein the operations further comprise:
obtaining, by a second network device, information identifying the first network device as a classifying device for classifying the particular connection to the server,
wherein the second set of messages are transmitted to the first network device by the second network device; and
subsequent to the client device switching an association with the second network device to the third network device:
transmitting, by the second network device to the third device, the information identifying the first network device as the classifying device for classifying the particular connection to the network.

17. The non-transitory computer readable medium of claim 9, wherein the particular connection to the server comprises:
at least one Open Systems Interconnection (OSI) layer 4 parameter;
a first Internet Protocol (IP) address for the client device; and
a second IP address for the server.

18. A non-transitory computer readable medium comprising instructions which, when executed by one or more devices, causes performance of operations comprising:
forwarding, by a first network device, a first set of messages corresponding to a particular connection to a server, the first set of messages being forwarded between a client device and a server via the first network device without being transmitted through a second network device or a third network device;
forwarding, by a second network device, a second set of messages corresponding to the particular connection to the server, the second set of messages being forwarded between the client device and the server without being transmitted through the first network device or the third network device;
receiving, by the third network device, a copy of the first set of messages from the first network device and a copy of the second set of messages from the second network device; and
analyzing, by the third network device, both the first set of messages and the second set of messages to obtain a classification associated with the particular connection to the server.

19. The non-transitory computer readable medium of claim 18,
wherein the first network device is a first access point,
wherein the client device is associated with the first access point during the transmission of the first set of messages,
wherein the client device is associated with a second access point during the transmission of the second set of messages,
wherein the copy of the first set of messages is received by the third network device from the first access point, and
wherein the copy of second set of messages is received by the third network device from the second access point.

20. The non-transitory computer readable medium of claim 18, wherein at least a portion of the first set of messages and at least a portion of the second set of messages are needed for obtaining the classification for the particular connection.
